(19) United States
(12) Patent Application Publication
(10) Pub. No.: US 2003/0065920 A1
(43) Pub. Date: Apr. 3, 2003

(54) Method and apparatus for using host authentication for automated public key certification

(75) Inventors: Messaoud Benantar, Austin, TX (US); John Dayka, New Paltz, NY (US); Thomas L. Gindin, Potomac, MD (US); James W. Sweeny, Millbrook, NY (US)

Correspondence Address: WILLIAM KINNAMAN, JR., IBM Corporation, Intellectual Property Law Department, 2455 South Road, M/S P386, Poughkeepsie, NY, 12601, US

(73) Assignee: International Business Machines Corporation, Armonk, NY

(21) Appl. No.: 09/968,126

(22) Filed: Oct. 1, 2001

(51) Int. Cl. H04L 9/00

(52) U.S. Cl. 713/175

(57) ABSTRACT

A method and apparatus for creating a digital certificate for a subject in an information handling system in which users of a host system authenticate themselves to the host system by presenting a host user ID and a host password. The host system has a host authentication system associated with it for automatically authenticating users to the host system using the host authentication information. Upon receiving a certification request from a subject, a certificate authority determines whether the certification request is for a general user certificate or for a host user certificate. If the certification request is for a general user certificate, the certificate authority places the request in a queue for processing by a human administrator. If the certification request is for a host user certificate, the certificate authority obtains a host user ID and password from the requester and authenticates the requester by presenting this host authentication information to the host authentication system. The host authentication system authenticates the requester by comparing the password presented by the requester with the password stored in the record of the host user registry corresponding to the user ID presented by the requester. If the requester is authenticated by the host authentication system as being a host user, the certificate authority creates a host user certificate for the requester. The host user certificate assigns to the requester a common name that is the obtained from the host user registry rather than from the requester.

### BACKGROUND OF THE INVENTION

1. Field of the Invention

This invention relates a method and apparatus for creating a digital certificate for a subject in an information handling system and, more particularly, to a method and apparatus for generating such a digital certificate for a subject having a user identity on a host system.

2. Description of the Related Art

1. Introduction

Public key (or asymmetric) encryption systems differ from secret key (or symmetric) encryption systems in their use of keys. In a symmetric encryption system, the same key is used both to convert a plaintext message M to a ciphertext message C (by encrypting the plaintext message) and to recover the original plaintext message M from the ciphertext message C (by decrypting the ciphertext message). In a public key encryption system, on the other hand, a public key is used to encrypt a plaintext message, while a private key known only to the recipient is used to decrypt the ciphertext message. Public key encryption systems are secure since, even though a public key may be known, it is computationally infeasible to generate the corresponding private key.

Unlike symmetric encryption systems, public key encryption systems do not require a secure method of establishing a key between a pair of communicating parties. On the other hand, some means is needed to authenticate a recipient's public key to a would-be sender—i.e., that the public key in fact belongs to the intended recipient and not to an impostor masquerading as the intended recipient.

The conventional method for authenticating a public key of an entity uses certificate authorities and digital signatures. Digital signatures are commonly created by generating a fixed-length digest of the original message (including an indication of the sender), using any one of a number of secure one-way hash functions. The message digest is then encrypted with the private key of a public-private key pair to generate the signature. Anyone with access to the public key can verify the signature by using the public key to decrypt the signature, generating a new message digest of the original message using the same hash function, and comparing the two message digests. On the other hand, only the entity possessing the private signature key can generate the signature. Note that in the special case of digital signatures, the encryption (signature) key is kept private, while the corresponding decryption (verification) key is published.

Certificate authorities (CAs) are a part of a Public Key Infrastructure (PKI) that has been provided for authenticating public keys of other entities. A certificate authority, also referred to as a certification authority, authenticates a public key of another entity by signing (with its own private signature key) a message that says, in effect, “Entity A has the public key K”. The signed message, containing the original message together with the digital signature, is called a digital certificate. Anyone can verify the signature of the certificate authority by using the public verification key of the certificate authority in the manner described above. (For the purposes of the present discussion, it will be assumed that the certificate authority itself has been authenticated. In practice, this is done using a chain of certificate authorities beginning at a root authority.)

A digital certificate created by a certificate authority cryptographically binds the subject name that it contains (i.e., the certificate holder) with its public cryptographic key. As a result, a strong and a trusted binding or simply association between the certificate holder and its public key becomes public information, yet tamper proof and reliable. Key to this reliability is the digital signature that the certificate authority stamps on a certificate before it is released for use. Subsequently, whenever the certificate lands in an application service its signature is verified before its subject holder is authenticated.

Although the present invention is not limited to any particular certificate format, a particularly common one is the X.509 v3 digital certificate, an International Telecommunications Union (ITU) standard that has been adopted by the Internet Engineering Task Force (IETF). The X.509 v3 certificate format is described in RFC 2459, “Internet X.509 Public Key Infrastructure” (January 1999), available from the IETF and incorporated herein by reference.

Digital certificates and related concepts are described at pages 57-76 of the IBM publication “Ready for e-business: OS/390 Security Server Enhancements”, SG24-5158-00 (December 1998), as well as in the McGill University thesis of Marc Branchaud entitled “A Survey of Public Key Infrastructures” (March 1997), both of which are incorporated herein by reference.

(Note, a certificate authority may be a standalone entity or may be front-ended by a registration authority (RA). With the latter, the registration authority authorizes the information to be certified by the certificate authority. The former has the certificate authority performing both tasks. This difference is irrelevant to the ideas disclosed here. Therefore, the use of the term, “CA” in the paragraphs below should be understood to mean either case, standalone CA or RA/CA combination.)

A common use for digital certificates is in Secure Sockets Layer (SSL) protocol, described in the IBM publication portion referenced above. A certificate authority operates an SSL-protected Web site for requesting certificates. When a subject visits the site, HTML tags in the Web page direct the Web browser to generate a public-private key pair and signed request for a digital certificate. This is sent to the CA server when the user clicks on the “submit” button. If the Web site is further protected by HTTP “Basic Authentication”, the subject is forced to authenticate with a user ID and password. All this can be accomplished with standard HTML. The mechanism for extracting the name from the user's credential would vary depending on the host operating system.

2. Problem Statement

The process involved in creating and signing a digital certificate is known as public key certification. It starts with the subject submitting a certificate request to the CA containing the subject's name and public key. The request is digitally signed by the subject in order to show proof that the subject does indeed own the public key being certified. The CA verifies the signature by using the public key contained in the request. Assuming this is successful, the CA must then verify the accuracy of the name in the request. Herein lies the problem. How is this performed? Typically, this is done in one of two ways (or some combination of the two): manually and automatically.

When processed manually, the request is queued for approval by a human administrator. The administrator performs some database look to verify the name information or perhaps contacts the subject by follow-up telephone call. Either case would require that additional information be passed to the certificate authority as part of the request (employee number, Social Security number, telephone number, pre-issued PIN, mother's maiden name, etc.). If the information checks out, the administrator approves the request. The drawback of this procedure is that anything done manually is subject to human error, as is evident from recent highly publicized cases of erroneous certification. Also, it is costly.

When processed automatically, the subject sends his or her e-mail address as part of the name information in the certificate request. The certificate authority creates the certificate and sends instructions on how to pick it up to the e-mail address. Thus the certificate can only be used by the subject if the subject supplied an accurate e-mail address. The drawback of this procedure is that it really just binds a public key to an e-mail address. Any common name information, if supplied with the request, is not verified.

Some certificate authorities require subjects to preregister before they can request certificates. The preregistration records the subject's name and other information and assigns a passphrase or PIN. This in effect the builds of a redundant user registry. Also, it doesn't really solve anything, since the preregistration records would need to be verified manually. The Internet Engineering Task Force (IETF) Sacred Working Group RFC draft entitled “PKI Enrollment Information” (file draft-ietf-sacred-pkienrollinfo-00.txt) describes just such a system.

### SUMMARY OF THE INVENTION

In general, the present invention contemplates a method and apparatus for creating a digital certificate for a subject in an information handling system in which users of a host system authenticate themselves to the host system by presenting a host user ID and a host password. The host system has a host authentication system associated with it for automatically authenticating users to the host system using the host authentication information. Upon receiving a certification request from a subject, a certificate authority determines whether the certification request is for a general user certificate or for a host user certificate. If the certification request is for a general user certificate, the certificate authority places the request in a queue for processing by a human administrator.

If the certification request is for a host user certificate, the certificate authority obtains a host user ID and password from the requester and authenticates the requester by presenting this host authentication information to the host authentication system. The host authentication system authenticates the requester by comparing the password presented by the requester with the password stored in the record of the host user registry corresponding to the user ID presented by the requester. If the requester is authenticated by the host authentication system as being a host user, the certificate authority creates a host user certificate for the requester. The host user certificate assigns to the requester a common name that is the obtained from the host user registry rather than from the requester.

The present invention exploits the fact that all host systems have registries of host users. A record for a host user in a host registry contains the host user's subject ID (user ID), (common) name, system permissions, and perhaps other information. When requesting authentication by a host system at login, a host user presents a host user ID and password for verification. If they are correct, the security manager of the host system reads the registry record to create the user's credential.

For a certificate authority that is responsible for creating certificates for host users, the subject of the certificate request is the host user. If the certificate authority resides on the host system itself (or has a secure link to the host remotely) and is part of the trusted computing base, then it may retrieve the subject's name from the credential if the subject is forced to authenticate with a user ID and password during the certificate-requesting process. The certificate authority verifies the signature on the request and extracts the public key from it, as usual. However, any name information, if passed as part of the request, may be discarded in favor of the previously verified name extracted from the credential.

The advantage of the present invention is that the certification process can be automated and still provide accurate name information in the issued certificates. An additional advantage is that the host user's now verified user ID may also be included in the certificate as part of the host identity mappings extension described in the commonly owned copending application of the same inventors, Ser. No. 09/862,792, filed May 22, 2001, entitled “Password Exposure Elimination for Digital Signature Coupling With a Host Identity” and incorporated herein by reference.

### BRIEF DESCRIPTION OF THE DRAWINGS

FIG. 1 shows an information handling system incorporating the present invention.

FIG. 2 shows the user registry of the host system shown in FIG. 1.

FIG. 3 shows the processing for a request for a general user certificate.

FIG. 4 shows the processing for a request for a host user certificate.

FIG. 5 shows a simplified layout of an X.509 digital certificate.

### DESCRIPTION OF THE PREFERRED EMBODIMENT

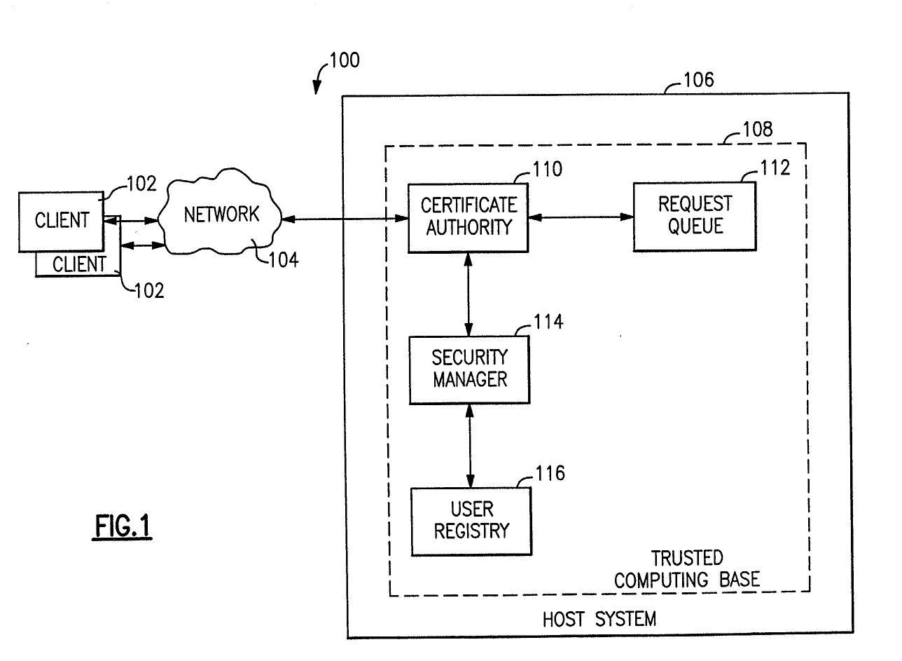

FIG. 1 shows an information handling system 100 incorporating the present invention. More particularly, information handling system 100 is a client/server system comprising one or more clients 102 coupled via a network 104 to a host system 106. In a preferred embodiment, each client 102 may comprise a suitably programmed personal computer workstation having an HTTP-compliant Web browser such as Netscape Navigator or Microsoft Internet Explorer, while network 104 may comprise a TCP/IP network such as the Internet or a corporate intranet. (In this specification, references to a “client” may be to a machine and programs running thereon or to a human user of the machine, or to both, as the context dictates.)

Host system 106 may comprise any suitable hardware/software platform comprising an operating system (OS) running on a server. Suitable such hardware/software platforms include an IBM OS/390 operating system running on an IBM S/390 or zSeries server, an IBM z/OS operating system running on an IBM zSeries server, an IBM OS/400 operating system running on an IBM AS/400 or iSeries server, an IBM AIX operating system running on an IBM RS/6000 or pSeries Server, and a UNIX (including Linux) operating system running on any one of a number of hardware platforms.

Host system 106 contains a trusted computing base 108, consisting of those components that are trusted to perform such security functions as user authentication and certificate generation. Included within trusted computing base 108 are a certificate authority 110 (CA), which generates digital certificates for users who properly authenticate themselves. Certificate authority 110 interacts with a request queue 112. Certificate authority 110 also interacts with a security manager 114, which handles security for the host system 106 generally, performing such tasks as authentication and access control. In an embodiment in which host system 106 comprises an IBM OS/390 or z/OS operating system, security manager 114 may comprise the Security Server component of the operating system.

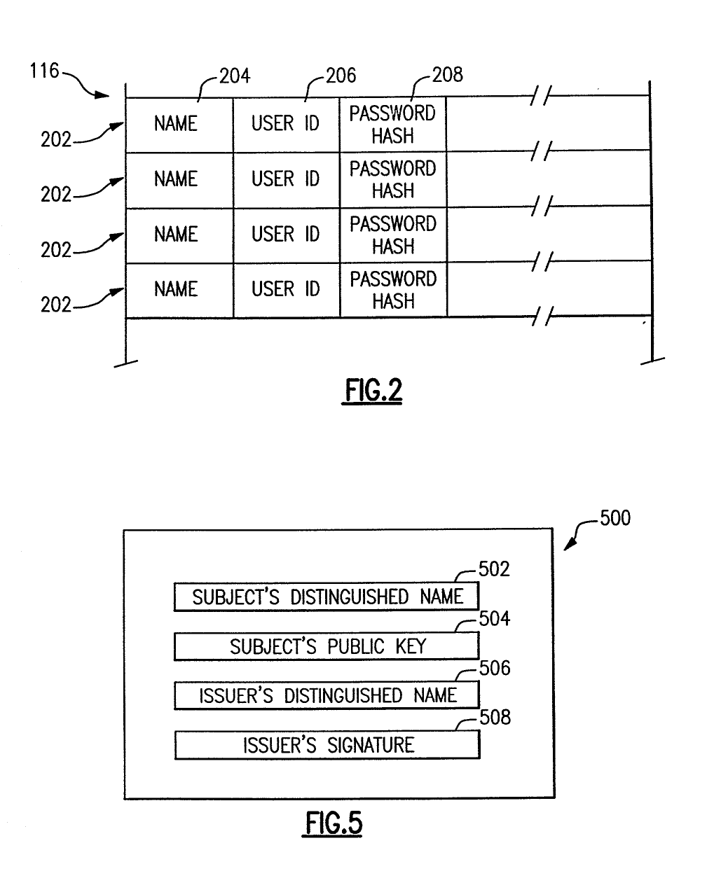

Security manager 114 accesses a user registry 116 containing host authentication information. Referring to FIG. 2, user registry 116 contains a record 202 for each user who is registered to the system. Each record in turn contains a common name 204 (e.g., “Tom H. User”), a user ID 206 (e.g., “TUSER”), and a hash 208 of the clear password, as well as other information relating to the user such as permissions and the like. FIG. 5 shows a simplified layout of an X.509 digital certificate 500. (There are fields other than those shown, but they are not relevant to the present discussion.) As shown in the figure, the digital certificate 500 includes the subject's distinguished name 502, the subject's public key 504, the issuer's distinguished name 506, and the issuer's signature 508. In the embodiment shown, the subject of the certificate 500 would be a particular client 102 (or the human user associated with that client), while the issuer would be the certificate authority 110. The distinguished name (DN) of a subject or issuer is formed by concatenating a series of relative distinguished names (RDNs) corresponding to nodes in a tree known as a directory information tree (DIT). Thus, the distinguished name CN=John Doe, OU=Research, O=Widgets.com, C=US is the concatenation (beginning from the root of the tree) of the RDNs C=US, O=Widgets.com, OU=Research and CN=John Doe, where C signifies country, O signifies organization, OU signifies organizational unit, and CN signifies common name.

A hypothetical scenario illustrating the operation of the present invention will now be described. Assume that Widgets.com, a corporation with an Internet presence, is operating the certificate authority 110 on the host system 106. The application that is the certificate authority 110 is part of the trusted computing base 108 for the host system 106 and thus has access to the host user registry 116. The certificate authority 110 can issue two different types of browser certificates 500. Of these, a first type, reflecting current practice, is for general clients 102. For these the client 102 submits as part of the request his public key, his common name, and some other identifying information such as Social Security number, credit card information, and the like. These requests are approved by the a human administrator before a certificate 500 is issued. When issued, the subject's distinguished name (DN) will have the following form:

CN=user-supplied-common-name, OU=General Client, OU=Widgets CA, O=Widgets.com, C=US

The second type of certificate, 500 which is generated in accordance with the present invention, is for clients 102 that have host identities, i.e., user IDs on the host system 106. For these the client 102 submits as part of the request his public key, together with his host user ID and password. Note that the client 102 does not supply his or her common name. Instead, the common name is determined by reading the entry 204 in the host user registry 116, as described below. When issued, the subject's distinguished name will have the following form:

CN=user-name-from-registry, OU=Host User, OU=Widgets CA, O=Widgets.com, C=US

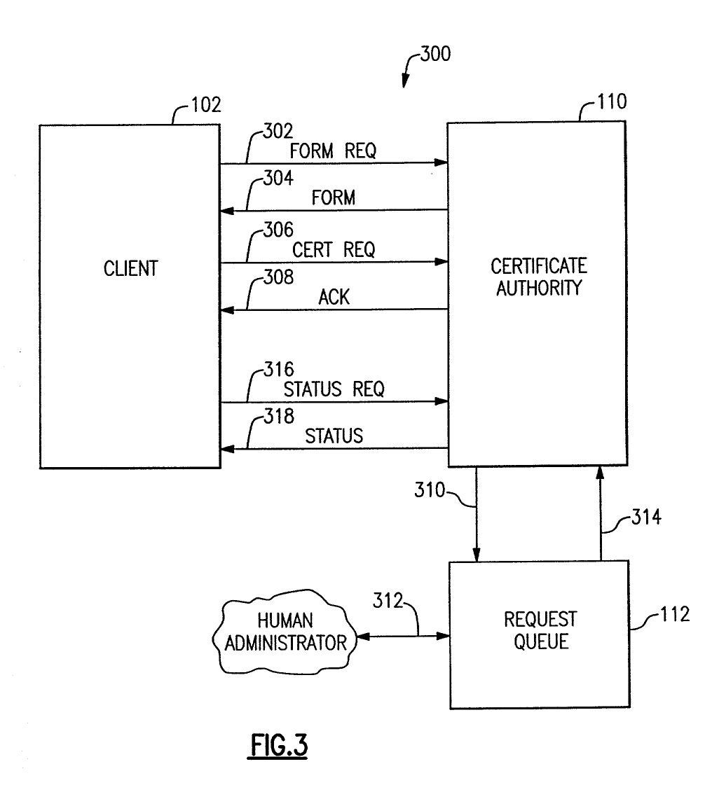

FIG. 3 shows the procedure 300 for processing a request from a general user (John Q. Public, in this particular example) for a general user certificate. 500

The client 102 initiates the procedure 300 by sending an HTTP request for a request form for a general user certificate 500 to a first URL (URL1) associated with the certificate authority 110 (step 302). The certificate authority 110 responds by returning a request form for a general user certificate 500 (step 304), which the client fills out and returns to a second URL (URL2) associated with the certificate authority 110 (step 306). To complete the request form, the client 102 generates a public-private key pair and signs the public key, which it includes along with other returned request information, such as common name (CN), Social Security number (SSN) and the like. Preferably, the secure transfer protocol HTTPS (which uses the SSL protocol) is used the send the request for a user certificate 500 to the certificate authority 110. As described at pages 74-75 of the IBM publication referenced above, the SSL protocol establishes a session key between the client 102 and the certificate authority for the encrypted exchange of data.

Upon receiving the request and recognizing it (in a manner to be described below) as being one for a general user certificate, 500 the certificate authority 110 verifies the signature of the requester and, if it is valid, places the request on the request queue 112 (step 310) for action by the human administrator. The administrator examines the information supplied and makes a decision on whether to approve the request or not (step 312), which is communicated back to the request queue 112 and thence to the certificate authority 110 (step 314). Optionally, the administrator may modify (correct) the information supplied, including the common name. This approval process is asynchronous to the request. Accordingly, immediately upon receiving the request, the certificate authority 110 sends an acknowledgment to the client 102, acknowledging that the request has been received and providing instructions on how to retrieve the certificate 500 later, assuming it is approved (step 308).

At a later point in time, the client 102 checks on the status of the certificate request (step 316). If it has been approved and created, the certificate authority returns it to the client (step 318). The returned certificate 500 has a subject's distinguished name 502 of:

CN=John Q. Public, OU=General Client, OU=Widgets CA, O=Widgets.com, C=US

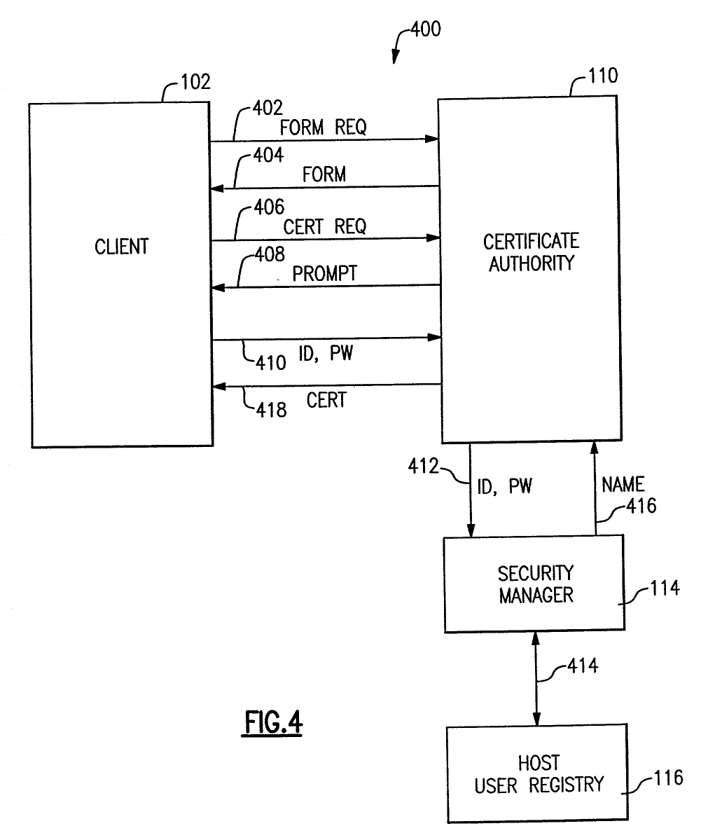

FIG. 4 shows the procedure 400 of the present invention for processing a request from a host user (Tom H. User, in this particular example) for a host user certificate. 500

The client 102 initiates the procedure 400 by sending an HTTP request for a certificate request form to a first URL (URL1) associated with the certificate authority 110 (step 402). The certificate authority 110 responds by returning a certificate request form (step 404), which the client 102 fills out and returns to a second URL (URL2) associated with the certificate authority 110 (step 406). To complete the certificate request form, the client 102 generates a public-private key pair and signs the public key, which it includes along with the other returned request information. Preferably, as in procedure 300, the secure transfer protocol HTTPS is used the send the request for a host user certificate 500 to the certificate authority 110. Note that in this case no common name information is sent.

Upon receiving the request and recognizing it as being one for a host user certificate, 500 the certificate authority 110 verifies the signature of the requester and, if the signature is valid, prompts the client 102 for a user ID and password (step 408). The client 102 responds with the values of the user ID (e.g., “TUSER”) and password for the host user (step 410). In step 408, the certificate authority 110 may determine the request type by examining the completed request form for an indication of the type of certificate 500 requested. Alternatively, the certificate authority 110 may determine the request type by using a different URL2 for receiving requests for host user certificates 500 than for receiving requests for general user certificates 500. Preferably, the URL2 used for receiving requests for host user certificates 500 (unlike the URL2 used for receiving requests for general user certificates 500) is password protected. If it is, then the prompt for a user ID and password may be generated automatically as part of the HTTP protocol. However the user ID and password are transmitted to the certificate authority 100, at least the password is transmitted in encrypted form to prevent its discovery by an unauthorized third party.

Upon receiving the user ID and password values from the client 102, the certificate authority 110 authenticates them by making a call to the security manager 114, passing on the received user ID and password values (ID, PW) as parameters (step 412). The security manager 114 in turn authenticates the received user ID and password by retrieving from the user registry 116 the stored hash 208 of the password corresponding to the presented user ID and determining whether it matches a similarly generated hash of the presented password (step 414).

If the authentication information is correct (i.e., the user ID is in the registry 116 and the hashes of the passwords match), the security manager 114 authenticates the user and returns the previously authenticated name information 204 (NAME) from the user registry record 202 to the certificate authority 110 (step 416).

The certificate authority 110 then uses this previously authenticated information to build a certificate 500 for the client 102 and return it to the client immediately (step 418), without having to wait for the approval of a human administrator. The returned certificate 500 would have a subject distinguished name 502 of:

CN=Tom H. User, OU=Host User, OU=Widgets CA, O=Widgets.com, C=US

While a particular embodiment has been shown and described, various modifications will be apparent to those skilled in the art.

What is claimed is:

1. In an information handling system in which users of a host system authenticate themselves to the host system by presenting host authentication information, the host system having a host authentication system associated with it for automatically authenticating users to the host system using the host authentication information, a method for creating a digital certificate for a subject, comprising the steps of:
receiving a request from a subject for a digital certificate based upon host authentication information;
authenticating the subject by presenting host authentication information received from the subject to the host authentication system; and
if the subject is authenticated by the host authentication system as being a user of the host system, creating a digital certificate for the subject based upon the received host authentication information, the digital certificate containing name information for the subject obtained from a user registry of the host authentication system.

2. The method of claim 1 in which the receiving step comprises the steps of:
receiving a request from a subject for a digital certificate; and
determining whether the request is for a digital certificate based upon host authentication information, the authentication step being performed only if the request is for a digital certificate based upon host authentication information.

3. The method of claim 2, further comprising the step of:
if the request is a for a digital certificate other than one based upon host authentication information, placing the request in a queue for processing by a human administrator.

4. The method of claim 1 in which the authenticating step comprises the step of:
requesting host authentication information from the subject.

5. The method of claim 1 in which the host authentication information comprises a user ID and a password.

6. The method of claim 1 in which the name information for the subject obtained from the user registry comprises a common name.

7. The method of claim 1 in which the digital certificate contains public key information.

8. In an information handling system in which users of a host system authenticate themselves to the host system by presenting host authentication information, the host system having a host authentication system associated with it for automatically authenticating users to the host system using the host authentication information, apparatus for creating a digital certificate for a subject, comprising:
means for receiving a request from a subject for a digital certificate based upon host authentication information;
means for authenticating the subject by presenting host authentication information received from the subject to the host authentication system; and
means for creating a digital certificate for the subject based upon the received host authentication information if the subject is authenticated by the host authentication system as being a user of the host system, the digital certificate containing name information for the subject obtained from a user registry of the host authentication system.

9. The apparatus of claim 8 in which the receiving means comprises:
means for receiving a request from a subject for a digital certificate; and
means for determining whether the request is for a digital certificate based upon host authentication information, the authentication means being operative only if the request is for a digital certificate based upon host authentication information.

10. The apparatus of claim 9, further comprising:
means for placing the request in a queue for processing by a human administrator if the request is a for a digital certificate other than one based upon host authentication information.

11. The apparatus of claim 8 in which the authenticating means comprises:
means for requesting host authentication information from the subject.

12. The apparatus of claim 8 in which the host authentication information comprises a user ID and a password.

13. The apparatus of claim 8 in which the name information for the subject obtained from the user registry comprises a common name.

14. The apparatus of claim 8 in which the digital certificate contains public key information.

15. A program storage device readable by a machine, tangibly embodying a program of instructions executable by the machine to perform method steps for creating a digital certificate for a subject in an information handling system in which users of a host system authenticate themselves to the host system by presenting host authentication information, the host system having a host authentication system associated with it for automatically authenticating users to the host system using the host authentication information, the method steps comprising:
receiving a request from a subject for a digital certificate based upon host authentication information;
authenticating the subject by presenting host authentication information received from the subject to the host authentication system; and
if the subject is authenticated by the host authentication system as being a user of the host system, creating a digital certificate for the subject based upon the received host authentication information, the digital certificate containing name information for the subject obtained from a user registry of the host authentication system.

16. The program storage device of claim 15 in which the receiving step comprises the steps of:
receiving a request from a subject for a digital certificate; and
determining whether the request is for a digital certificate based upon host authentication information, the authentication step being performed only if the request is for a digital certificate based upon host authentication information.

17. The program storage device of claim 16, the method steps further comprising:
if the request is a for a digital certificate other than one based upon host authentication information, placing the request in a queue for processing by a human administrator.

18. The program storage device of claim 15 in which the authenticating step comprises the step of:
requesting host authentication information from the subject.

19. The program storage device of claim 15 in which the host authentication information comprises a user ID and a password.

20. The program storage device of claim 15 in which the name information for the subject obtained from the user registry comprises a common name.

21. The program storage device of claim 1 in which the digital certificate contains public key information.
